(19) United States
(12) Patent Application Publication
(10) Pub. No.: US 2025/0075021 A1
(43) Pub. Date: Mar. 6, 2025

(54) THERMOPLASTIC ELASTOMER ARTICLES COMPRISING STYRENE BLOCK COPOLYMER AND RUBBER

(71) Applicant: Avient Corporation, Avon Lake, OH (US)

(72) Inventors: Jiren Gu, Crystal Lake, IL (US); Hochul Jung, Algonquin, IL (US); John Swanson, Lakewood, OH (US)

(73) Assignee: Avient Corporation, Avon Lake, OH (US)

(21) Appl. No.: 18/726,396

(22) PCT Filed: Jan. 4, 2023
(86) PCT No.: PCT/US2023/010157

§ 371 Date: Jul. 2, 2024

Related U.S. Application Data
(60) Provisional application No. 63/296,655, filed on Jan. 5, 2022.

(51) Int. Cl. C08F 287/00; C08J 3/18; C08J 3/24; C08K 5/01; C08K 5/14

(52) U.S. Cl. CPC C08F 287/00; C08J 3/18; C08J 3/24; C08K 5/01; C08K 5/14; C08J 2353/02

(57) ABSTRACT

Embodiments of the present disclosure are directed to thermoplastic elastomer articles comprising a crosslinked reaction product of styrene block copolymer, rubber, and silane. The styrene block copolymer comprises at least one terminal polymer block A. The at least one terminal polymer block A comprises a vinyl compound having para-alkyl styrene. The rubber comprises at least one of ethylene propylene diene rubber, silicone rubber, and nitrile butadiene rubber. The styrene block copolymer and the rubber are silane grafted and silane crosslinked. The silane crosslinking is at least one of intramolecular silane crosslinking and intermolecular silane crosslinking.

### CLAIM OF PRIORITY

This application claims the benefit of U.S. Provisional Patent Application Ser. No. 63/296,655 bearing Attorney Docket Number 1202202 and filed on Jan. 5, 2022, which is hereby incorporated by reference in its entirety.

### TECHNICAL FIELD

Embodiments of the present disclosure are generally related to thermoplastic elastomer articles, and are specifically related to thermoplastic elastomer articles of styrene block copolymer and rubber having increased chemical and heat resistance.

### BACKGROUND

Thermoplastic elastomer articles including rubber may have desirable mechanical properties, such as tensile strength at break and tensile elongation at break. However, these articles may not have the chemical resistance (e.g., oil resistance) or heat resistance necessary for certain applications in the healthcare, automotive, and electronic fields.

Accordingly, a continual need exists for improved thermoplastic elastomer articles that have improved chemical and heat resistance for the aforementioned applications.

### SUMMARY

Embodiments of the present disclosure are directed to thermoplastic elastomer articles comprising a crosslinked reaction product of styrene block copolymer, rubber, and silane, which have increased chemical and heat resistance.

According to one embodiment, a thermoplastic elastomer article is provided. The thermoplastic elastomer article comprises a crosslinked reaction product of styrene block copolymer, rubber, and silane. The styrene block copolymer comprises at least one terminal polymer block A. The at least one terminal polymer block A comprises a vinyl compound having para-alkylstyrene. The rubber comprises at least one of ethylene propylene diene rubber, silicone rubber, and nitrile butadiene rubber. The styrene block copolymer and the rubber are silane grafted and silane crosslinked. The silane crosslinking is at least one of intramolecular silane crosslinking and intermolecular silane crosslinking.

Additional features and advantages of the embodiments described herein will be set forth in the detailed description which follows, and in part will be readily apparent to those skilled in the art from that description or recognized by practicing the embodiments described herein, including the detailed description, which follows and the claims.

### DETAILED DESCRIPTION

Reference will now be made in detail to various embodiments of thermoplastic elastomer articles, specifically thermoplastic elastomer articles comprising the crosslinked reaction product of styrene block copolymer, rubber, and silane. The styrene block copolymer comprises at least one terminal polymer block A. The at least one terminal polymer block A comprise a vinyl compound having para-alkylstyrene. The rubber comprises at least one of ethylene propylene diene rubber, silicone rubber, and nitrile butadiene rubber. The styrene block copolymer and the rubber are silane grafted and silane crosslinked. The silane crosslinking is at least one of intramolecular silane crosslinking and intermolecular silane crosslinking.

The disclosure should not be construed as limited to the embodiments set forth herein. Rather, these embodiments are provided so that this disclosure will be thorough and complete, and will fully convey the subject matter to those skilled in the art.

### Definitions

Unless otherwise defined, all technical and scientific terms used herein have the same meaning as commonly understood by one of ordinary skill in the art. The terminology used in the disclosure herein is for describing particular embodiments only and is not intended to be limiting.

Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used in the specification and the appended claims, the singular forms “a,” “an,” and “the” are intended to include the plural forms as well, unless the context clearly indicates otherwise. Thus, for example, reference to “a” component includes aspects having two or more such components, unless the context clearly indicates otherwise.

The term “wt %,” as described herein, refers to the weight fraction of the individual reactants of the formulation used to produce the crosslinked reaction product that comprises the thermoplastic elastomer article, unless otherwise noted. For simplicity purposes, “wt %” will be referred to throughout as the amount in the thermoplastic elastomer article.

The term “melt flow rate,” as described herein, refers to the ability of a material's melt to flow under pressure as measured according to ASTM D1238 at the given temperature and given weight.

The term “density,” as described herein, refers to the mass per unit volume of a material as measured according to ASTM D792 at 23° C.

The term “specific gravity,” as described herein, refers to the ratio of the density of a material to the density of water as measured according to ASTM D792 at 23° C.

The term “Mooney viscosity,” as described herein, refers to the viscosity reached after a rotor rotates for a given time interval at the specified temperature as measured according to ASTM D1646.

The term “yield,” as described herein, refers to the point on a stress-strain curve that indicates the limit of elastic behavior and the beginning of plastic behavior.

The term “tensile strength at yield,” as described herein, refers to the maximum stress that a material can withstand while being stretched before it begins to change shape permanently as measured according to ASTM D638 at 23° C. and a rate of strain of 0.85 mm/s.

The term “tensile elongation at yield,” as described herein, refers to the ratio between the increased length and initial length at the yield point as measured according to ASTM D638 at 23° C. and a rate of strain of 0.85 mm/s.

The term “tensile strength at break,” as described herein, refers to the maximum stress that a material can withstand while stretching before breaking as measured according to ASTM D638 at 23° C. and a rate of strain of 0.85 mm/s.

The term “tensile elongation at break,” as described herein, refers to the ratio between increased length and initial length after breakage as measured according to ASTM D638 at 23° C. and a rate of strain of 0.85 mm/s.

The term “Shore A hardness,” as described herein, refers to the hardness of a material as measured according to ASTM D2240.

The term “similar hardness,” as used herein refers to a hardness within 10 (i.e., ±10).

The terms “improved chemical and heat resistance” or “increased chemical and heat resistance,” as used herein, refers to a thermoplastic elastomer article as described herein having a reduced oil immersion weight increase and a reduced compression set as compared to a comparative thermoplastic elastomer article having a similar hardness.

The term “compression set,” as described herein, refers to the ability of a material to return to its original thickness after prolonged compressive stress as measured according to ASTM D395 at the temperature indicated.

The term “boiling point,” as described herein, is measured using thermogravimetric analysis (TGA).

The term “silane grafted,” as described herein, refers to the styrene block copolymer or the rubber having a silane side chain connected to the polymer main chain. The grafted silane allow the styrene block copolymer or the rubber to intramolecular silane crosslink or intermolecular silane crosslink.

The term “intramolecular silane crosslinking,” as described herein, refers to silane crosslinking that occurs when the styrene block copolymer or the rubber crosslinks with itself.

The term “intermolecular silane crosslinking,” as described herein, refers to silane crosslinking that occurs when the styrene block copolymer crosslinks with the rubber.

The term “copolymer,” as described herein, refers to a polymer formed when two or more different monomers are linked in the same chain.

The term “block,” as described herein, refers to a portion of a macromolecule, comprising many constitutional units, that has at least one feature which is not present in the adjacent portions.

The term “olefin block copolymer (OBC),” as described herein, refers to a polymer comprising a plurality of blocks or segments, each comprising an ethylene or propylene repeating unit and an alpha-olefin repeating unit in different mole fractions.

The term “polyolefin,” as described herein, refers to a polymer has that has a crystalline and amorphous phase made from prepared from olefin monomers.

The term “polyolefin elastomer (POE),” as described herein, refers to a low crystalline (i.e., less than or equal to 25% crystalline) polymer prepared from olefin monomers

The term “ethylene alpha-olefin copolymer,” as described herein, refers to an ethylene alpha-olefin copolymer comprising C₃-C₁₂ olefins.

As discussed hereinabove, thermoplastic elastomer articles including rubber may have desirable mechanical properties, such as tensile strength at break and tensile elongation at break. However, these articles may not have the chemical resistance (e.g., oil resistance) or heat resistance necessary for certain applications in the healthcare, automotive, and electronic fields.

Disclosed herein are thermoplastic elastomer articles, which mitigate the aforementioned problems. Specifically, the thermoplastic elastomer articles disclosed herein comprise a crosslinked reaction product of styrene block copolymer, rubber, and silane, which results in a chemical and heat resistant thermoplastic elastomer article. The styrene block copolymer comprises at least one terminal polymer block A. The at least one terminal polymer block A comprises a vinyl compound having para-alkylstyrene. The rubber comprises at least one of ethylene propylene diene rubber, silicone rubber, and nitrile butadiene rubber. The styrene block copolymer and the rubber are silane grafted and silane crosslinked. The silane crosslinking is at least one of intramolecular silane crosslinking and intermolecular silane crosslinking. This occurrence of silane crosslinking, along with the presence of the para-alkylstyrene and the rubber, provides increased chemical and heat resistance.

The thermoplastic elastomer articles disclosed herein may generally be described as the crosslinked reaction product of styrene block copolymer, rubber, and silane.

### Styrene Block Copolymer

The styrene block copolymer of the thermoplastic elastomer article comprises at least one terminal polymer block A. The at least one terminal polymer block A comprises a vinyl compound having para-alkylstyrene. As described hereinabove, the presence of the para-alkylstyrene, along with the presence of the rubber and the occurrence of silane crosslinking, produces a thermoplastic elastomer article having improved chemical and heat resistance.

In embodiments, the para-alkyl styrene may comprise para-methylstyrene. In embodiments, both terminal polymer blocks of the styrene block copolymer may comprise terminal polymer block A.

In embodiments, the styrene block copolymer may further comprise at least one interior polymer block B. The at least one interior polymer block B may comprise conjugated diene. In embodiments, the conjugated diene may comprise butadiene, isoprene, 2-3, dimethyl-1,3-butadiene, 1,3-pentadiene, 1,3-hexadiene, or a combination thereof. In embodiments, greater than or equal to 70% of the carbon-carbon double bonds of the polymer block B may be hydrogenated.

In embodiments, the styrene block copolymer may include one or more additional blocks comprising additional comonomers. In embodiments, the additional comonomers of the styrene block copolymer may comprise butadiene, isoprene, styrene-ethylene/butylene-styrene block copolymers (SEBS), styrene isoprene block copolymers (SIS), styrene-(ethylene/propylene)-styrene block copolymer (SEEPS), or a combination thereof.

In embodiments, the styrene block copolymer may be included in amounts greater than or equal to 2 wt %. In embodiments, the amount of the styrene block copolymer may be limited (e.g., less than or equal to 60 wt %). In embodiments, the amount of the styrene block copolymer in the thermoplastic elastomer article may be greater than or equal to 2 wt %, greater than or equal to 6 wt %, greater than or equal to 10 wt %, or even greater than or equal to 14 wt %. In embodiments, the amount of the styrene block copolymer in the thermoplastic elastomer article may be less than or equal to 60 wt %, less than or equal to 55 wt %, less than or equal to 50 wt %, less than or equal to 45 wt %, less than or equal to 40 wt %, less than or equal to 35 wt %, or even less than or equal to 30 wt %. In embodiments, the amount of the styrene block copolymer in the thermoplastic elastomer article may be from 2 wt % to 60 wt %, from 2 wt % to 55 wt %, from 2 wt % to 50 wt %, from 2 wt % to 45 wt %, from 2 wt % to 40 wt %, from 2 wt % to 35 wt %, from 2 wt % to 30 wt %, from 6 wt % to 60 wt %, from 6 wt % to 55 wt %, from 6 wt % to 50 wt %, from 6 wt % to 45 wt %, from 6 wt % to 40 wt %, from 6 wt % to 35 wt %, from 6 wt % to 30 wt %, from 10 wt % to 60 wt %, from 10 wt % to 55 wt %, from 10 wt % to 50 wt %, from 10 wt % to 45 wt %, from 10 wt % to 40 wt %, from 10 wt % to 35 wt %, from 10 wt % to 30 wt %, from 14 wt % to 60 wt %, from 14 wt % to 55 wt %, from 14 wt % to 50 wt %, from 14 wt % to 45 wt %, from 14 wt % to 40 wt %, from 14 wt % to 35 wt %, or even from 14 wt % to 30 wt %, or any and all sub-ranges formed from any of these endpoints.

Suitable commercial embodiments of the para-alkylstyrene block copolymer may be available under the SEPTON brand from Kuraray, such as grade V9461 and grade V9475, as well as other para-alkylstyrene block polymers.

### Rubber

As described hereinabove, the presence of the rubber, along with the presence of the para-alkylstyrene and the occurrence of silane crosslinking, produces a thermoplastic elastomer article having improved chemical and heat resistance.

In embodiments, the rubber is included in amounts greater than or equal to 1 wt %. In embodiments, the amount of the rubber may be limited (e.g., less than or equal to 65 wt %). In embodiments, the amount of the rubber in the thermoplastic elastomer article may be greater than or equal to 1 wt %, greater than or equal to 5 wt %, greater than or equal to 10 wt %, greater than or equal to 15 wt %, or even greater than or equal to 20 wt %. In embodiments, the amount of the rubber in the thermoplastic elastomer article may be less than or equal to 65 wt %, less than or equal to 60 wt %, less than or equal to 55 wt %, or even less than or equal to 50 wt %. In embodiments, the amount of the rubber in the thermoplastic elastomer article may be from 1 wt % to 65 wt %, from 1 wt % to 60 wt %, from 1 wt % to 55 wt %, from 1 wt % to 50 wt %, from 5 wt % to 65 wt %, from 5 wt % to 60 wt %, from 5 wt % to 55 wt %, from 5 wt % to 50 wt %, from 10 wt % to 65 wt %, from 10 wt % to 60 wt %, from 10 wt % to 55 wt %, from 10 wt % to 50 wt %, from 15 wt % to 65 wt %, from 15 wt % to 60 wt %, from 15 wt % to 55 wt %, from 15 wt % to 50 wt %, from 20 wt % to 65 wt %, from 20 wt % to 60 wt %, from 20 wt % to 55 wt %, or even from 20 wt % to 50 wt %, or any and all sub-ranges formed from any of these endpoints.

The rubber comprises at least one of ethylene propylene diene rubber, silicone rubber, and nitrile butadiene rubber.

### Ethylene Propylene Diene Rubber

The ethylene propylene diene rubber is the polymerized reaction product of ethylene, propylene, and diene. In embodiments, the ethylene diene rubber may comprise one or more of ethyldiene norbornene, dicyclopentadiene, and vinyl norbornene.

In embodiments, the ethylene propylene diene rubber may be included in amounts greater than or equal to 5 wt %. In embodiments, the amount of the ethylene propylene diene rubber may be limited (e.g., less than or equal to 45 wt %). In embodiments, the amount of the ethylene propylene diene rubber in the thermoplastic elastomer article may be greater than or equal to 5 wt %, greater than or equal to 7 wt %, greater than or equal to 10 wt %, greater than or equal to 13 wt %, greater than or equal to 15 wt % or even greater than or equal to 17 wt %. In embodiments, the amount of the ethylene propylene diene rubber in the thermoplastic elastomer article may be less than or equal to 45 wt %, less than or equal to 43 wt %, less than or equal to 40 wt %, less than or equal to 37 wt %, less than or equal to 35 wt %, or even less than or equal to 33 wt %. In embodiments, the amount of the ethylene propylene diene rubber in the thermoplastic elastomer may be from 5 wt % to 45 wt %, from 5 wt % to 43 wt %, from 5 wt % to 40 wt %, from 5 wt % to 37 wt %, from 5 wt % to 35 wt %, from 5 wt % to 33 wt %, from 7 wt % to 45 wt %, from 7 wt % to 43 wt %, from 7 wt % to 40 wt %, from 7 wt % to 37 wt %, from 7 wt % to 35 wt %, from 7 wt % to 33 wt %, from 10 wt % to 45 wt %, from 10 wt % to 43 wt %, from 10 wt % to 40 wt %, from 10 wt % to 37 wt %, from 10 wt % to 35 wt %, from 10 wt % to 33 wt %, from 13 wt % to 45 wt %, from 13 wt % to 43 wt %, from 13 wt % to 40 wt %, from 13 wt % to 37 wt %, from 13 wt % to 35 wt %, from 13 wt % to 33 wt %, from 15 wt % to 45 wt %, from 15 wt % to 43 wt %, from 15 wt % to 40 wt %, from 15 wt % to 37 wt %, from 15 wt % to 35 wt %, from 15 wt % to 33 wt %, from 17 wt % to 45 wt %, from 17 wt % to 43 wt %, from 17 wt % to 40 wt %, from 17 wt % to 37 wt %, from 17 wt % to 35 wt %, or even from 17 wt % to 33 wt %, or any and all sub-ranges formed from any of these endpoints.

In embodiments, the ethylene propylene diene rubber may comprise a density greater than or equal to 0.80 g/cm³ or even greater than or equal to 0.85 g/cm³. In embodiments, the ethylene propylene diene rubber may comprise a density less than or equal to 0.95 g/cm³ or even less than or equal to 0.90 g/cm³. In embodiments, the ethylene propylene diene rubber may comprise a density from 0.80 g/cm³ to 0.95 g/cm³, from 0.80 g/cm³ to 0.90 g/cm³, from 0.85 g/cm³ to 0.95 g/cm³, or even from 0.85 g/cm³ to 0.90 g/cm³, or any and all sub-ranges formed from any of these endpoints.

In embodiments, the ethylene propylene diene rubber may comprise a Mooney viscosity (ML 1+4, 125° C.) greater than or equal to 45, greater than or equal to 60, or even greater than or equal to 75. In embodiments, the ethylene propylene diene rubber may have a Mooney viscosity (ML 1+4, 125° C.) less than or equal to 130, less than or equal to 115, or even less than or equal to 100. In embodiments, the ethylene propylene diene rubber may comprise a Mooney viscosity (ML 1+4, 125° C.) from 45 to 130, from 45 to 115, from 45 to 100, from 60 to 130, from 60 to 115, from 60 to 100, from 75 to 130, from 75 to 115, or even from 75 to 100, or any and all sub-ranges formed from any of these endpoints.

Suitable commercial embodiments of the ethylene propylene diene rubber may be available under the NORDEL brand from Dow Chemical Company, such as grade IP 4785HM. Table 1 shows certain properties of NORDEL IP 4785HM.

TABLE 1

| | NORDEL IP 4785HM |
|---|---|
| Density (g/cm³) | 0.880 |
| Mooney viscosity (ML 1 + 4) | 85 (125° C.) |

### Silicone Rubber

In embodiments, the silicone rubber may comprise at least one vinyl functional group. In embodiments, the silicone rubber may comprise high consistency silicone rubber. In embodiments, the silicone rubber may comprise polydimethylsiloxane.

In embodiments, the silicone rubber may be included in amounts greater than or equal to 1 wt %. In embodiments, the amount of the silicone rubber may be limited (e.g., less than or equal to 40 wt %). In embodiments, the amount of silicone rubber in the thermoplastic elastomer article may be greater than or equal to 1 wt %, great than or equal to 3 wt %, greater than or equal to 5 wt %, greater than or equal to 7 wt %, or even greater than or equal to 10 wt %. In embodiments, the amount of silicone rubber in the thermoplastic article may be less than or equal to 40 wt %, less than or equal to 35 wt %, less than or equal to 30 wt %, less than or equal to 25 wt %, or even less than or equal to 20 wt %. In embodiments, the amount of silicone rubber in the thermoplastic elastomer article may be from 1 wt % to 40 wt %, from 1 wt % to 35 wt %, from 1 wt % to 30 wt %, from 1 wt % to 25 wt %, from 1 wt % to 20 wt %, from 3 wt % to 40 wt %, from 3 wt %, to 35 wt %, from 3 wt % to 30 wt %, from 3 wt % to 25 wt %, from 3 wt % to 20 wt %, from 5 wt % to 40 wt %, from 5 wt % to 35 wt %, from 5 wt % to 30 wt %, from 5 wt % to 25 wt %, from 5 wt % to 20 wt %, from 7 wt % to 40 wt %, from 7 wt % to 35 wt %, from 7 wt % to 30 wt %, from 7 wt % to 25 wt %, from 7 wt % to 20 wt %, from 10 wt % to 40 wt %, from 10 wt % to 35 wt %, from 10 wt % to 30 wt %, from 10 wt % to 25 wt %, or even from 10 wt % to 20 wt %, or any and all sub-ranges formed from any of these endpoints.

Suitable commercial embodiments of the silicone rubber may be available under the TSE221 brand from Momentive.

### Nitrile Butadiene Rubber

In embodiments, the nitrile butadiene rubber is included in amounts greater than or equal to 35 wt %. In embodiments, the amount of the nitrile butadiene rubber may be limited (e.g., less than or equal to 65 wt %). In embodiments, the amount of the nitrile butadiene rubber in the thermoplastic elastomer article may be greater than or equal to 35 wt %, greater than or equal to 37 wt %, greater than or equal to 40 wt %, greater than or equal to 43 wt %, or even greater than or equal to 45 wt %. In embodiments, the amount of the nitrile butadiene rubber in the thermoplastic elastomer article may be less than or equal to 65 wt %, less than or equal to 63 wt %, less than or equal to 60 wt %, less than or equal to 57 wt %, or even less than or equal to 55 wt %. In embodiments, the amount of the nitrile butadiene rubber in the thermoplastic elastomer article may be from 35 wt % to 65 wt %, from 35 wt % to 63 wt %, from 35 wt % to 60 wt %, from 35 wt % to 57 wt %, from 35 wt % to 55 wt %, from 37 wt % to 65 wt %, from 37 wt % to 63 wt %, from 37 wt % to 60 wt %, from 37 wt % to 57 wt %, from 37 wt % to 55 wt %, from 40 wt % to 65 wt %, from 40 wt % to 63 wt %, from 40 wt % to 60 wt %, from 40 wt % to 57 wt %, from 40 wt % to 55 wt %, from 43 wt % to 65 wt %, from 43 wt % to 63 wt %, from 43 wt % to 60 wt %, from 43 wt % to 57 wt %, from 45 wt % to 65 wt %, from 45 wt % to 63 wt %, from 45 wt % to 60 wt %, from 45 wt % to 57 wt %, or even from 45 wt % to 55 wt %, or any and all sub-ranges formed from any of these endpoints.

In embodiments, the nitrile butadiene rubber may comprise a density greater than or equal to 0.95 g/cm³ or even greater than or equal to 1.00 g/cm³. In embodiments, the nitrile butadiene rubber may comprise a density less than or equal to 1.15 g/cm³ or even less than or equal to 1.10 g/cm³. In embodiments, the nitrile butadiene rubber may comprise a density from 0.95 g/cm³ to 1.15 g/cm³, from 0.95 g/cm³ to 1.10 g/cm³, from 1.00 g/cm³ to 1.15 g/cm³, or even from 1.00 g/cm³ to 1.10 g/cm³, or any and all sub-ranges formed from any of these endpoints.

In embodiments, the nitrile butadiene rubber may comprise a Mooney viscosity (M+L, 100° C.) greater than or equal to 35 or even greater than or equal to 45. In embodiments, the nitrile butadiene rubber may comprise a Mooney viscosity (M+L, 100° C.) less than or equal to 65 or even less than or equal to 55. In embodiments, the nitrile butadiene rubber may comprise a Mooney viscosity (M+L, 100° C.) from 35 to 65, from 35 to 55, from 45 to 65, or even from 45 to 55, or any and all sub-ranges formed from any of these endpoints.

In embodiments, the nitrile butadiene rubber may comprise an acrylonitrile content greater than or equal to 20 wt %, greater than or equal to 25 wt % or even greater than or equal to 30 wt %. In embodiments, the nitrile butadiene rubber may comprise an acrylonitrile content less than or equal to 50 wt %, less than or equal to 45 wt %, less than or equal to 40 wt % or even less or equal to 35 wt %. In embodiments, the nitrile butadiene rubber may comprise an acrylonitrile content from 20 wt % to 50 wt %, from 20 wt % to 45 wt %, from 20 wt % to 40 wt %, from 20 wt % to 35 wt %, from 25 wt % to 50 wt %, from 25 wt % to 45 wt %, from 25 wt % to 40 wt %, from 25 wt % to 35 wt %, from 30 wt % to 50 wt %, from 30 wt % to 45 wt %, from 30 wt % to 40 wt %, or even from 30 wt % to 35 wt %, or any and all sub-ranges formed from any of these endpoints.

Suitable commercial embodiments of the nitrile butadiene rubber are available under the CHEMIGUM brand from Synthomer, such as grade P615D. Table 2 shows certain properties of CHEMIGUM P615D.

TABLE 2

| | CHEMIGUM P615D |
|---|---|
| Density (g/cm³) | 1.04 |
| Mooney viscosity | 50 |
| (ML 1 + 4, 100° C.) | |
| acrylonitrile content (%) | 33 |

### Silane

As stated hereinabove, the styrene block copolymer and the rubber are silane grafted and silane crosslinked. The occurrence of silane crosslinking results in a thermoplastic elastomer article having improved chemical and heat resistance.

Various silanes are considered suitable for the present thermoplastic elastomer articles. In embodiments, the silane may comprise vinyl trialkoxysilane. For example, in embodiments, the silane may comprise vinyl trimethoxysilane, vinyl triethoxysilane, or a combination thereof.

In embodiments, the silane is included in amounts greater than or equal to 0.5 wt % such that the styrene block copolymer and the rubber are silane grafted and silane crosslinked to produce a thermoplastic elastomer article having improved chemical and heat resistance. In embodiments, the amount of silane may be limited (e.g., less than or equal to 5 wt %). In embodiments, the amount of silane in the thermoplastic elastomer article may be greater than or equal to 0.5 wt %, greater than or equal to 1 wt %, or even greater than or equal to 2 wt %. In embodiments, the amount of silane in the thermoplastic elastomer articles article may be less than or equal to 5 wt % or even less than or equal to 3 wt %. In embodiments, the amount of silane in the thermoplastic elastomer article may be from 0.5 wt % to 5 wt %, from 0.5 wt % to 3 wt %, from 1 wt % to 5 wt %, from 1 wt % to 3 wt %, from 2 wt % to 5 wt %, or even from 2 wt % to 3 wt %, or any and all sub-ranges formed from any of these endpoints.

In embodiments, the silane may have a specific gravity greater than or equal to 0.9 or even greater than or equal to 0.95. In embodiments, the silane may have a specific gravity less than or equal to 1.05 or even less than or equal to 1. In embodiments, the silane may have a specific gravity from 0.9 to 1.05, from 0.9 to 1, from 0.95 to 1.05, or even from 0.95 to 1, or any and all sub-ranges formed from any of these endpoints.

In embodiments, the silane may have a boiling point greater than or equal to 75° C. or even greater than or equal to 100° C. In embodiments, the silane may have a boiling point less than or equal to 150° C. or even less than or equal to 125° C. In embodiments, the silane may have a boiling point from 75° C. to 150° C., from 75° C. to 125° C., from 100° C. to 150° C., or even from 100° C. to 125° C., or any and all sub-ranges formed from any of these endpoints.

Suitable commercial embodiments of the silane are available under the SILQUEST brand from Momentive, such as grade A-171.

In embodiments, the silane may be included in a solution comprising organic peroxide such that the silane is better dispersed within the styrene block copolymer and the rubber, leading to improved silane grafting and silane crosslinking. In embodiments, the organic peroxide may comprise dicumyl peroxide. In embodiments, the amount of organic peroxide in the thermoplastic elastomer article may be greater than or equal to 0.05 wt % or even greater than or equal to 0.1 wt %. In embodiments, the amount of organic peroxide in the thermoplastic elastomer article may be less than or equal to 1 wt % or even less than or equal to 0.5 wt %. In embodiments, the amount of organic peroxide in the thermoplastic elastomer article may be from 0.05 wt % to 1 wt %, from 0.05 wt % to 0.5 wt %, from 0.1 wt % to 1 wt %, or even from 0.1 wt % to 0.5 wt %, or any and all sub-ranges formed from any of these endpoints.

In embodiments, the organic peroxide may have a density greater than or equal to 1 g/cm³ or even greater than or equal to 1.05 g/cm³. In embodiments, the organic peroxide may have a density less than or equal to 1.2 g/cm³ or even less than or equal to 1.15 g/cm³. In embodiments, the organic peroxide may have a density from 1 g/cm³ to 1.2 g/cm³, from 1 g/cm³ to 1.15 g/cm³, from 1.05 g/cm³ to 1.2 g/cm³, or even from 1.05 g/cm³ to 1.15 g/cm³, or any and all sub-ranges formed from any of these endpoints.

In embodiments, the organic peroxide may have a boiling point greater than or equal to 75° C. or even greater than or equal to 100° C. In embodiments, the organic peroxide may have a boiling point less than or equal to 150° C. or even less than or equal to 125° C. In embodiments, the organic peroxide may have a boiling point from 75° C. to 150° C., from 75° C. to 125° C., from 100° C. to 150° C., or even from 100° C. to 125° C., or any and all sub-ranges formed from any of these endpoints.

Suitable commercial embodiments of the organic peroxide are available under the PERKADOX brand from AkzoNobel, such as grade BC-FF.

### Thermoplastic Elastomer Article

As described herein, the occurrence of silane crosslinking, along with the presence of the para-alkylstyrene and the rubber, produces a thermoplastic elastomer article having increased chemical and heat resistance.

In embodiments, the styrene block copolymer and the rubber may be silane grafted and silane crosslinked. In embodiments, the at least one terminal polymer block A comprising a vinyl compound having para-alkylstyrene may be silane grafted and silane crosslinked. In embodiments, both terminal polymer blocks of the styrene block copolymer may be terminal polymer block A and both terminal blocks may be silane grafted and silane crosslinked. In embodiments, the styrene block copolymer may comprise terminal polymer blocks A and at least one interior polymer block B comprising conjugated diene, and both the terminal blocks and the at least one interior polymer block may be silane grafted and silane crosslinked. Having the terminal blocks and the at least one interior polymer block silane crosslinked may lead to increased crosslinking, which may improve the chemical and heat resistance of the thermoplastic elastomer article.

In embodiments, the silane crosslinking is at least one of intramolecular silane crosslinking and intermolecular silane crosslinking. For example, in embodiments, the styrene block copolymer may be crosslinked with the rubber.

In embodiments, the thermoplastic elastomer article may have a compression set (125° C.) greater than or equal to 20%, greater than or equal to 25%, or even greater than or equal to 30%. In embodiments, the thermoplastic elastomer article may have a compression set (125° C.) less than or equal to 55%, less than or equal to 50%, less than or equal to 45%, or even less than or equal to 40%. In embodiments, the thermoplastic elastomer article may have a compression set (125° C.) from 20% to 55%, from 20% to 50%, from 20% to 45%, from 20% to 40%, from 25% to 55%, from 25% to 50%, from 25% to 45%, from 25% to 40%, from 30% to 55%, from 30% to 50%, from 30% to 45%, or even from 30% to 40%, or any and all sub-ranges formed from any of these endpoints.

In embodiments, the thermoplastic elastomer article may have a Shore A hardness greater than or equal to 30, greater than or equal to 35, or even greater than or equal to 40. In embodiments, the thermoplastic elastomer article may have a Shore A hardness less than or equal to 80, less than or equal to 75, or even less than or equal to 70. In embodiments, the thermoplastic elastomer article may have a Shore A hardness from 30 to 80, from 30 to 75, from 30 to 70, from 35 to 80, from 35 to 75, from 35 to 70, from 35 to 80, from 35 to 75, from 35 to 70, from 40 to 80, from 40 to 75, or even from 40 to 70, or any and all sub-ranges formed from any of these endpoints.

In embodiments, the thermoplastic elastomer article may have a tensile strength at break greater than or equal to 1 MPa, greater than or equal to 2 MPa, or even greater than or equal to 3 MPa. In embodiments, the thermoplastic elastomer article may have a tensile strength at break less than or equal to 8 MPa, less than or equal to 7 MPa, or even less than or equal to 6 MPa. In embodiments, the thermoplastic elastomer article may have a tensile strength at break from 1 MPa to 8 MPa, from 1 MPa to 7 MPa, from 1 MPa to 6 MPa, from 2 MPa to 8 MPa, from 2 MPa to 7 MPa, from 2 MPa to 6 MPa, from 3 MPa to 8 MPa, from 3 MPa to 7 MPa, or even from 3 MPa to 6 MPa, or any and all sub-ranges formed from any of these endpoints.

In embodiments, the thermoplastic elastomer article may have a tensile elongation at break greater than or equal to 100%, greater than or equal to 125%, or even greater than or equal to 150%. In embodiments, the thermoplastic elastomer article may have a tensile elongation at break less than or equal to 400%, less than or equal to 350%, or even less than or equal to 300%. In embodiments, the thermoplastic elastomer article may have a tensile elongation at break from 100% to 400%, from 100% to 350%, from 100% to 300%, from 125% to 400%, from 125% to 350%, from 125% to 300%, from 150% to 400%, from 150% to 350%, or even from 150% to 300%, or any and all sub-ranges formed from any of these endpoints.

As exemplified in the Examples section below, the thermoplastic elastomer articles described herein comprising the crosslinked reaction product of styrene block copolymer, rubber, and silane have increased chemical and heat resistance.

### Moisture Cure Catalyst

In embodiments, the thermoplastic elastomer article may comprise a moisture cure catalyst to initiate silane crosslinking of the styrene block copolymer and the rubber such that crosslinked reaction product is a moisture cure reaction product.

In embodiments, the moisture cure catalyst may comprise organotin (e.g., dibutylin dilaurate), carboxylic acids, metal complex compounds (e.g., metal carboxylates), aluminum triacetyl acetonate, nickel tetraacetyl acetonate, chromium hexaacetyl acetonate, titanium tetraacetyl acetonate, and metal alkoxides (e.g., aluminum ethoxide, aluminum propoxide, titanium ethoxide, titanium propoxide), or a combination thereof.

In embodiments, the catalyst is blended with the styrene block copolymer, the rubber, and the silane during silane grafting. In other embodiments, the catalyst is added to the extruded formulation wherein the styrene block copolymer and the rubber are silane grafted. The styrene block copolymer and the rubber that are silane grafted will crosslink upon exposure to moisture (e.g., air).

### Polyolefin and Polyolefin Elastomer

In embodiments, the thermoplastic elastomer article may further comprise at least one of polyolefin and polyolefin elastomer to help improve the chemical and heat resistance of the thermoplastic elastomer article.

In embodiments, the polyolefin and/or the polyolefin elastomer is included in amounts (i.e., amount of polyolefin (wt %)+amount of polyolefin elastomer (wt %)) greater than or equal to 1 wt %. In embodiments, the polyolefin and/or the polyolefin elastomer may be limited (e.g., less than or equal to 23 wt %) such that a reduced compression set may be achieved. In embodiments, the amount of the polyolefin and/or the polyolefin elastomer in the thermoplastic elastomer article may be greater than or equal to 1 wt %, greater than or equal to 3 wt %, or even greater than or equal to 5 wt %, or even greater than or equal to 7 wt %. In embodiments, the amount of the polyolefin and/or the polyolefin elastomer in the thermoplastic elastomer article may be less than or equal to 23 wt %, less than or equal to 20 wt %, less than or equal to 17 wt %, less than or equal to 15 wt %, less than or equal to 13 wt %, or even less than or equal to 10 wt %. In embodiments, the amount of the polyolefin and/or the polyolefin elastomer in the thermoplastic elastomer article may be from 1 wt % to 23 wt %, from 1 wt % to 20 wt %, from 1 wt % to 17 wt %, from 1 wt % to 15 wt %, from 1 wt % to 13 wt %, from 1 wt % to 10 wt %, from 3 wt % to 23 wt %, from 3 wt % to 20 wt %, from 3 wt % to 17 wt %, from 3 wt % to 15 wt %, from 3 wt % to 13 wt %, from 3 wt % to 10 wt %, from 5 wt % to 23 wt %, from 5 wt % to 20 wt %, from 5 wt % to 17 wt %, from 5 wt % to 15 wt %, from 5 wt % to 13 wt %, from 5 wt % to 10 wt %, from 7 wt % to 23 wt %, from 7 wt % to 20 wt %, from 7 wt % to 17 wt %, from 7 wt % to 15 wt %, from 7 wt % to 13 wt %, or even from 7 wt % to 10 wt %, or any and all sub-ranges formed from any of these endpoints.

In embodiments, the polyolefin may comprise polypropylene. In embodiments, the polypropylene may comprise a polypropylene homopolymer (i.e., composed of propylene monomers) or a polypropylene copolymer having greater than 50 wt % propylene monomer and an additional comonomer such as C₂ and C₄-C₁₂ alpha olefins.

In embodiments, the polypropylene may comprise a melt flow rate (230° C./2.16 kg) greater than or equal to 0.1 g/10 min, greater than or equal to 0.5 g/10 min, greater than or equal to 1 g/10 min or even greater than or equal to 3 g/10 min. In embodiments, the polypropylene may comprise a melt flow rate (230° C./2.16 kg) less than or equal to 10 g/10 min or even less than or equal to 5 g/10 min. In embodiments, the polypropylene may comprise a melt flow rate (230° C./2.16 kg) from 0.1 g/10 min to 10 g/10 min, from 0.1 g/10 min to 5 g/10 min, from 0.5 g/10 min to 10 g/10 min, from 0.5 g/10 min to 5 g/10 min, from 1 g/10 min to 10 g/10 min, from 1 g/10 min to 5 g/10 min, from 3 g/10 min to 10 g/10 min, or even from 3 g/10 min to 5 g/10 min, or any and all sub-ranges formed from any of these endpoints.

In embodiments, the polypropylene may comprise a density greater than or equal to 0.8 g/cm³ or even greater than or equal to 0.85 g/cm³. In embodiments, the polypropylene may comprise a density less than or equal to 1.10 g/cm³ or even less than or equal to 1.00 g/cm³. In embodiments, the polypropylene may comprise a density from 0.80 g/cm³ to 1.10 g/cm³, from 0.80 g/cm³ to 1.00 g/cm³, from 0.85 g/cm³ to 1.10 g/cm³, or even from 0.85 g/cm³ to 1.00 g/cm³, or any and all sub-ranges formed from any of these endpoints.

In embodiments, the polypropylene may comprise a tensile strength at yield greater than or equal to 25 MPa or even greater than or equal to 30 MPa. In embodiments, the polypropylene may comprise a tensile strength at yield less than or equal to 45 MPa or even less than or equal to 40 MPa. In embodiments, the polypropylene may comprise a tensile strength at yield from 25 MPa to 45 MPa, from 25 MPa, to 40 MPa, from 30 MPa to 45 MPa, or even from 30 MPa to 40 MPa, or any and all sub-ranges formed from any of these endpoints.

In embodiments, the polypropylene may comprise a tensile elongation at yield greater than or equal to 3% or even greater than or equal to 5%. In embodiments, the polypropylene may comprise a tensile elongation at yield less than or equal to 20% or even less than or equal to 15%. In embodiments, the polypropylene may comprise a tensile elongation at yield from 3% to 20%, from 3% to 15%, from 5% to 20%, or even from 5% to 15%, or any and all sub-ranges formed from any of these endpoints.

Suitable commercial embodiments of the polypropylene are available under the FORMOLENE brand from Formosa Plastics, such as polypropylene homopolymer grade 1102KR. Table 3 shows certain properties of FORMOLENE 1102KR.

TABLE 3

| | FORMOLENE 1102KR |
|---|---|
| Melt flow rate | 4 |
| (230° C./2.16 kg) (g/10 min) | |
| Density (g/cm³) | 0.9 |
| Tensile strength at yield (MPa) | 36 |
| Tensile elongation at yield (%) | 9 |

In embodiments, the polyolefin elastomer may comprise olefin block copolymer, ethylene alpha-olefin copolymer, or a combination thereof. In embodiments, the polyolefin elastomer may comprise olefin block copolymer. In embodiments, the polyolefin elastomer may comprise ethylene alpha-olefin copolymer. In embodiments, the polyolefin elastomer may comprise olefin block copolymer and ethylene alpha-olefin copolymer.

In embodiments, the olefin block copolymer may comprise an ethylene alpha-olefin repeating unit. The ethylene alpha-olefin repeating unit is the polymerized reaction product of ethylene and C₃-C₁₂ olefins. For example, in embodiments, the ethylene alpha-olefin repeating unit may comprise ethylene-octene copolymer, ethylene-hexene copolymer, ethylene-butene copolymer, or a combination thereof.

In embodiments, the olefin block copolymer may have a melt flow rate (190° C./2.16 kg) greater than or equal to 1 g/10 min or even greater than or equal to 5 g/10 min. In embodiments, the olefin block copolymer may have a melt flow rate (190° C./2.16 kg) less than or equal to 25 g/10 min or even less than or equal to 20 g/10 min. In embodiments, the olefin block copolymer may have a melt flow rate (190° C./2.16 kg) from 1 g/10 min to 25 g/10 min, from 1 g/10 min to 20 g/10 min, from 5 g/10 min to 25 g/10 min, or even from 5 g/10 min to 20 g/10 min, or any and all sub-ranges formed from any of these endpoints.

In embodiments, the olefin block copolymer may have a density greater than or equal to 0.80 g/cm³ or even greater than or equal to 0.85 g/cm³. In embodiments, the olefin block copolymer may have a density less than or equal to 0.95 g/cm³ or even less than or equal to 0.90 g/cm³. In embodiments, the olefin block copolymer may have a density from 0.80 g/cm³ to 0.95 g/cm³, from 0.80 g/cm³ to 0.90 g/cm³, from 0.85 g/cm³ to 0.95 g/cm³, or even from 0.85 g/cm³ to 0.90 g/cm³, or any and all sub-ranges formed from any of these endpoints.

In embodiments, the olefin block copolymer may have a tensile strength greater than or equal to 1 MPa or even greater than or equal to 5 MPa. In embodiments, the olefin block copolymer may have a tensile strength less than or equal to 15 MPa or even less than or equal to 10 MPa. In embodiments, the olefin block copolymer may have a tensile strength from 1 MPa to 15 MPa, from 1 MPa to 10 MPa, from 5 MPa to 15 MPa, or even from 5 MPa to 10 MPa, or any and all sub-ranges formed from any of these endpoints.

In embodiments, the olefin block copolymer may have a tensile elongation greater than or equal to 1250% or even greater than or equal to 1500%. In embodiments, the olefin block copolymer may comprise a tensile elongation less than or equal to 2000% or even less than or equal to 1750%. In embodiments, the olefin block copolymer may have a tensile elongation from 1250% to 2000%, from 1250% to 1750%, from 1500% to 2000%, or even from 1500% to 1750%, or any and all sub-ranges formed from any of these endpoints.

In embodiments, the olefin block copolymer may have a Shore A hardness greater than or equal to 50 or even greater than or equal to 60. In embodiments, the olefin block copolymer may have a Shore A hardness less than or equal to 85 or even less than or equal to 75. In embodiments, the olefin block copolymer may have a Shore A hardness from 50 to 85, from 50 to 75, from 60 to 85, or even from 60 to 75, or any and all sub-ranges formed from any of these endpoints.

Suitable commercial embodiments of olefin block copolymer are available under the Infuse brand, such as 9500 and 9817, from Dow Chemical Company.

The ethylene alpha-olefin copolymer is the polymerized reaction product of ethylene and C₃-C₁₂ olefins. For example, in embodiments, the ethylene alpha-olefin copolymer may comprise ethylene-octene copolymer, ethylene-hexene copolymer, ethylene-butene copolymer, or a combination thereof.

In embodiments, the ethylene-alpha olefin copolymer may have a melt flow rate (190° C./2.16 kg) greater than or equal to 0.1 g/10 min or even greater than or equal to 0.25 g/10 min. In embodiments, the ethylene-alpha olefin copolymer may have a melt flow rate (190° C./2.16 kg) less than or equal to 3 g/10 min or even less than or equal to 1 g/10 min. In embodiments, the ethylene-alpha olefin copolymer may have a melt flow rate (190° C./2.16 kg) from 0.1 g/10 min to 3 g/10 min, from 0.1 g/10 min to 1 g/10 min, from 0.25 g/10 min to 3 g/10 min, or even from 0.25 g/10 min to 1 g/10 min, or any and all sub-ranges formed from any of these endpoints.

In embodiments, the ethylene-alpha olefin copolymer may have a density greater than or equal to 0.80 g/cm³ or even greater than or equal to 0.85 g/cm³. In embodiments, the ethylene-alpha olefin copolymer may have a density less than or equal to 0.95 g/cm³ or even less than or equal to 0.90 g/cm³. In embodiments, the ethylene-alpha olefin copolymer may have a density from 0.80 g/cm³ to 0.95 g/cm³, from 0.80 g/cm³ to 0.90 g/cm³, from 0.85 g/cm³ to 0.95 g/cm³, or even from 0.85 g/cm³ to 0.90 g/cm³, or any and all sub-ranges formed from any of these endpoints.

In embodiments, the ethylene-alpha olefin copolymer may have a Mooney viscosity (ML 1+4, 121° C.) greater than or equal to 20, greater than or equal to 30, or even greater than or equal to 40. In embodiments, the ethylene-alpha olefin copolymer may have a Mooney viscosity (ML 1+4, 121° C.) less than or equal to 70, less than or equal to 60, or even less than or equal to 50. In embodiments, the ethylene-alpha olefin copolymer may have a Mooney viscosity (ML 1+4, 121° C.) from 20 to 70, from 20 to 60, from 20 to 50, from 30 to 70, from 30 to 60, from 30 to 50, from 40 to 70, from 40 to 60, or even from 40 to 50, or any and all sub-ranges formed from any of these endpoints.

In embodiments, the ethylene-alpha olefin copolymer may have a tensile strength greater than or equal to 1 MPa or even greater than or equal to 2 MPa. In embodiments, the ethylene-alpha olefin copolymer may have a tensile strength less than or equal to 10 MPa or even less than or equal to 5 MPa. In embodiments, the ethylene-alpha olefin copolymer may have a tensile strength from 1 MPa to 10 MPa, from 1 MPa to 5 MPa, from 2 MPa to 10 MPa, or even from 2 MPa to 5 MPa, or any and all sub-ranges formed from any of these endpoints.

In embodiments, the ethylene-alpha olefin copolymer may have a tensile elongation greater than or equal to 750% or even greater than or equal to 1000%. In embodiments, the ethylene-alpha olefin copolymer may comprise a tensile elongation less than or equal to 1750% or even less than or equal to 1500%. In embodiments, the ethylene-alpha olefin copolymer may have a tensile elongation from 750% to 1750%, from 750% to 1500%, from 1000% to 1750%, or even from 1000% to 1500%, or any and all sub-ranges formed from any of these endpoints.

In embodiments, the ethylene-alpha olefin copolymer may have a Shore A hardness greater than or equal to 40 or even greater than or equal to 45. In embodiments, the ethylene-alpha olefin copolymer may have a Shore A hardness less than or equal to 60 or even less than or equal to 65. In embodiments, the ethylene-alpha olefin copolymer may have a Shore A hardness from 40 to 60, from 40 to 55, from 45 to 60, or even from 45 to 55, or any and all sub-ranges formed from any of these endpoints.

Suitable commercial embodiments of the ethylene-alpha olefin copolymer are available under the Engage brand, such as XLT 8677, from Dow Chemical Company.

### Thermoplastic Copolyester

In embodiments, the thermoplastic elastomer articles described herein may further comprise thermoplastic copolyester.

In embodiments, the amount of the thermoplastic copolyester in the thermoplastic elastomer article may be greater than or equal to 3 wt %, greater than or equal to 5 wt %, greater than or equal to 7 wt %, or even greater than or equal to 10 wt %. In embodiments, the amount of the thermoplastic copolyester in the thermoplastic elastomer article may be less than or equal to 20 wt %, less than or equal to 17 wt %, or even less than or equal to 15 wt %. In embodiments, the amount of the thermoplastic polyester in the thermoplastic elastomer article may be from 3 wt % to 20 wt %, from 3 wt % to 17 wt %, from 3 wt % to 15 wt %, from 5 wt % to 20 wt %, from 5 wt % to 17 wt %, from 5 wt % to 15 wt %, from 7 wt % to 20 wt %, from 7 wt % to 17 wt %, from 7 wt % to 15 wt %, from 10 wt % to 20 wt %, from 10 wt % to 17 wt %, or even from 10 wt % to 15 wt %, or any and all sub-ranges formed from any of these endpoints.

In embodiments, the thermoplastic copolyester may comprise a density greater than or equal to 1.10 g/cm³ or even greater than or equal to 1.15 g/cm³. In embodiments, the thermoplastic copolyester may comprise a density less than or equal to 1.30 g/cm³ or even less than or equal to 1.25 g/cm³. In embodiments, the polar elastomer may comprise a density from 1.10 g/cm³ to 1.30 g/cm³, from 1.10 g/cm³ to 1.25 g/cm³, from 1.15 g/cm³ to 1.30 g/cm³, or even from 1.15 g/cm³ to 1.25 g/cm³, or any and all sub-ranges formed from any of these endpoints.

In embodiments, the thermoplastic copolyester may comprise a tensile strength at break greater than or equal to 35 MPa or even greater than or equal to 40 MPa. In embodiments, the thermoplastic copolyester may comprise a tensile strength at break less than or equal to 55 MPa or even less than or equal to 50 MPa. In embodiments, the thermoplastic copolyester may comprise a tensile strength at break from 35 MPa to 55 MPa, from 35 MPa to 50 MPa, from 40 MPa to 55 MPa, or even from 40 MPa to 50 MPa, or any and all sub-ranges formed from any of these endpoints.

In embodiments, the thermoplastic copolyester may comprise a tensile elongation at break greater than or equal to 350% or even greater than or equal to 450%. In embodiments, the thermoplastic copolyester may comprise a tensile elongation at break less than or equal to 700% or even less than or equal to 600%. In embodiments, the thermoplastic copolyester may comprise a tensile elongation at break from 350% to 700%, from 350% to 600%, from 450% to 700%, or even from 450% to 600%, or any and all sub-ranges formed from any of these endpoints.

Suitable commercial embodiments of the thermoplastic copolyester may be available under the SKYPEL brand from SK Chemicals, such as grade G140D. Table 4 shows certain properties of SKYPEL G140D.

TABLE 4

| | SKYPEL G140D |
|---|---|
| Density (g/cm³) | 1.21 |
| Tensile strength at break (MPa) | 43 |
| Tensile elongation at break (%) | 500 |

### Plasticizer

In embodiments, the thermoplastic elastomer articles described herein may further comprise such that to reduce hardness and improve flow.

In embodiments, the plasticizer may comprise non-polar plasticizer (e.g., mineral oil).

In embodiments, the amount of the plasticizer in the thermoplastic elastomer article may be greater than or equal to 15 wt %, greater than or equal to 17 wt %, greater than or equal to 20 wt %, greater than or equal to 23 wt %, or even greater than or equal to 25 wt %. In embodiments, the amount of the plasticizer in the thermoplastic elastomer article may be less than or equal to 65 wt %, less than or equal to 60 wt %, less than or equal to 55 wt %, or even less than or equal to 50 wt %. In embodiments, the amount of the plasticizer in the thermoplastic elastomer article may be from 15 wt % to 65 wt %, from 15 wt % to 60 wt %, from 15 wt % to 55 wt %, from 15 wt % to 50 wt %, from 17 wt % to 65 wt %, from 17 wt % to 60 wt %, from 17 wt % to 55 wt %, from 17 wt % to 50 wt %, from 20 wt % to 65 wt %, from 20 wt % to 60 wt %, from 20 wt % to 55 wt %, from 20 wt % to 50 wt %, from 23 wt % to 65 wt %, from 23 wt % to 60 wt %, from 23 wt % to 55 wt %, from 23 wt % to 50 wt %, from 25 wt % to 65 wt %, from 25 wt % to 60 wt %, from 25 wt % to 55 wt %, or even from 25 wt % to 50 wt %, or any and all sub-ranges formed from any of these endpoints.

Suitable commercial embodiments of the plasticizer are available under the PURETOL brand from Petro-Canada, such as grade PSO 380.

### Additive

In embodiments, the thermoplastic elastomer article may further comprise an additive. In embodiments, the additive may comprise adhesion promoters; biocides; anti-fogging agents; anti-static agents; blowing and foaming agents; bonding agents and bonding polymers; polar copolymers (e.g., ethylene-vinyl acetate (EVA), ethylene butyl acrylate (EBA), or ethyl methacrylate (EMA)); dispersants; flame retardants and smoke suppressants; mineral fillers; initiators; lubricants; micas; pigments, colorants, and dyes; processing aids; release agents; silanes, titanates, and zirconates; slip and anti-blocking agents; stearates; ultraviolet light absorbers; viscosity regulators; waxes; or combinations thereof.

### Processing

In embodiments, the thermoplastic elastomer article described herein may be made with a batch process or continuous process.

In embodiments, the components of the thermoplastic elastomer article, including the styrene block copolymer and the rubber, may be added to an extruder (27 MM Leistriz Twin Extruder (L/D 52)) and blended. In embodiments, silane is added to the blend such that the styrene block copolymer and the rubber are silane grafted. In embodiments, the blending (e.g., in the barrel of the extruder) may be carried out at a temperature from 150° C. to 220° C.

Blending (also known as compounding) devices are well known to those skilled in the art and generally include feed means, especially at least one hopper for pulverulent materials and/or at least one injection pump for liquid materials; high-shear blending means, for example a co-rotating or counter-rotating twin-screw extruder, usually comprising a feed screw placed in a heated barrel (or tube); an output head, which gives the extrudate its shape; and means for cooling the extrudate, either by air cooling or by circulation of water. The extrudate is generally in the form of rods continuously exiting the device and able to be cut or formed into granules. However, other forms may be obtained by fitting a die of desired shape on the output die.

In embodiments, the shaped, silane-grafted blend may be cured such that the styrene block copolymer and the rubber are silane crosslinked. In embodiments, a moisture cure catalyst may be added to initiate silane crosslinking of the styrene block copolymer and the rubber. In embodiments, the catalyst is blended with the styrene block copolymer, the rubber, and the silane during silane grafting. In other embodiments, the catalyst is added at the extrusion step.

### EXAMPLES

Table 5 below shows sources of ingredients used to form the thermoplastic elastomer articles of Comparative Example C1 and Examples E1 to E13.

TABLE 5

| Ingredients | Brand | Source |
|---|---|---|
| polypropylene | FORMOLENE 1102KR | Formosa Plastics |
| para-methylstyrene block | SEPTON V9461 | Kuraray |
| copolymer | | |
| ethylene propylene diene | NORDEL IP 4785HM | Dow Chemicals |
| rubber | | |
| silicone rubber | TSE221 | Momentive |
| thermoplastic copolyester | SKYPEL G140D | SK Chemicals |
| nitrile butadiene rubber | CHEMIGUM P615D | Synthomer |
| mineral oil (plasticizer) | PURETOL PSO 380 | Petro-Canada |
| vinyltrimethoxy silane | SILQUEST A-171 | Momentive |
| dicumyl peroxide | PERKADOX BC-FF | AkzoNobel |

Table 6 below shows the formulations used to form and the certain properties of Comparative Example C1 and Examples E1 to E13. To prepare comparative and exemplary thermoplastic elastomer plaques, the components of the formulations listed in Table 6 were added into a 27 MM Leistriz Twin Exturder (L/D/52) and blended at barrel temperature of 193° C. and a rate of 5 rotations per second. The mixed formulation was extruded at a speed of 5 g/s. The extruded formulation was blended with 3% tin catalyst master match (MB). MB has a polyether carrier with 1.5% dibutylin dilaurate (MARK 1038, Galata Chemicals). The blended formulation was injection molded (i.e., shaped) to form a plaque. The plaque was conditioned at 90° C. and 90% relative humidity for 24 hours prior to measuring the properties listed in Table 6.

To measure the “oil immersion weight increase” listed in Table 6, the plaque having a diameter of 39 mm and a thickness of 3 mm was weighed and then immersed in IRM 903 oil for 3 days at 125° C. After immersion, the plaque was weighed and the weight percentage increase was calculated.

TABLE 6

Example
C1

| Ingredient | Parts | Wt % |
|---|---|---|
| FORMOLENE 1102KR | 45.00 | 18.04 |
| SEPTON V9461 | — | — |
| NORDEL IP 4785HM | 100.00 | 40.08 |
| KRATON G1641 | — | — |
| TSE221 | — | — |
| SKYPEL G140D | — | — |
| CHEMIGUM P615D | — | — |
| PURETOL PSO 380 | 100.00 | 40.08 |
| SILQUEST A-171 | 3.96 | 1.59 |
| PERKADOX BC-FF | 0.53 | 0.21 |
| TOTAL | 249.49 | 100.00 |

| | |
|---|---|
| Hardness (Shore A) | 66 |
| Tensile strength | 4.69 |
| at break (MPa) | |
| Tensile elongation at | 280 |
| break (%) | |
| Oil immersion weight | 103 |
| increase (125° C./3 days, %) | |
| Compression set (125° C./22 hr, %) | 44 |

| | Example | | | | | | | |
|---|---|---|---|---|---|---|---|---|
| | E1 | | E2 | | E3 | | E4 | |
| Ingredient | Parts | Wt % | Parts | Wt % | Parts | Wt % | Parts | Wt % |
| FORMOLENE | 45.00 | 17.98 | 25.00 | 9.63 | 30.00 | 10.53 | 25.00 | 8.94 |
| 1102KR | | | | | | | | |
| SEPTON V9461 | 50.00 | 19.98 | 50.00 | 19.26 | 50.00 | 17.56 | 50.00 | 17.88 |
| NORDEL IP 4785HM | 50.00 | 19.98 | 50.00 | 19.26 | 50.00 | 17.56 | 50.00 | 17.88 |
| PURETOL PSO 380 | 100.00 | 39.96 | 130.00 | 50.07 | 150.00 | 52.67 | 150.00 | 53.64 |
| SILQUEST A-171 | 4.55 | 1.82 | 3.86 | 1.49 | 4.00 | 1.40 | 3.87 | 1.38 |
| PERKADOX BC-FF | 0.70 | 0.28 | 0.78 | 0.30 | 0.80 | 0.28 | 0.77 | 0.28 |
| TOTAL | 250.25 | 100.00 | 259.64 | 100.00 | 284.80 | 100.00 | 279.64 | 100.00 |
| Hardness (Shore A) | 70 | | 42 | | 43 | | 40 | |
| Tensile strength | 6.76 | | 3.45 | | 3.24 | | 3.03 | |
| at break (MPa) | | | | | | | | |
| Tensile elongation at | 360 | | 280 | | 280 | | 290 | |
| break (%) | | | | | | | | |
| Oil immersion weight | 96 | | 107 | | 98 | | 98 | |
| increase (125° C./3 days, %) | | | | | | | | |

| | | | | |
|---|---|---|---|---|
| Compression set (125° C./22 hr, %) | 41 | 29 | 38 | 32 |

| | Example | | | | | |
|---|---|---|---|---|---|---|
| | E5 | | E6 | | E7 | |
| Ingredient | Parts | Wt % | Parts | Wt % | Parts | Wt % |
| FORMOLENE 1102KR | 45.00 | 18.01 | 35.00 | 13.23 | 20.0 | 8.93 |
| SEPTON V9461 | 25.00 | 10.01 | 25.00 | 9.45 | 25.00 | 11.16 |
| NORDEL IP 4785HM | 75.00 | 30.02 | 75.00 | 28.35 | 75.00 | 33.47 |
| PURETOL PSO 380 | 100.00 | 40.02 | 125.00 | 47.25 | 100.00 | 44.63 |
| SILQUEST A-171 | 4.21 | 1.68 | 3.79 | 1.43 | 3.40 | 1.52 |
| PERKADOX BC-FF | 0.65 | 0.26 | 0.76 | 0.29 | 0.68 | 0.30 |
| TOTAL | 249.86 | 100.00 | 264.55 | 100.00 | 224.08 | 100.00 |
| Hardness (Shore A) | 70 | | 55 | | 49 | |
| Tensile strength | 5.86 | | 3.59 | | 3.24 | |
| at break (MPa) | | | | | | |
| Tensile elongation at | 370 | | 260 | | 230 | |
| break (%) | | | | | | |
| Oil immersion weight | 96 | | 95 | | 112 | |
| increase (125° C./3 days, %) | | | | | | |
| Compression set (125° C./22 hr, %) | 43 | | 36 | | 30 | |
| | Example | | | | | |
| | E8 | | E9 | | E10 | |
| Ingredient | Parts | Wt % | Parts | Wt % | Parts | Wt % |
| FORMOLENE 1102KR | 30.00 | 12.01 | 30.00 | 11.27 | 30.00 | 8.87 |
| SEPTON V9461 | 100.00 | 40.05 | 100.00 | 37.57 | 100.00 | 29.56 |
| TSE221 | 14.00 | 5.61 | 30.00 | 11.27 | 100.00 | 29.56 |
| PURETOL PSO 380 | 100.00 | 40.05 | 100.00 | 37.57 | 100.00 | 29.56 |
| SILQUEST A-171 | 4.75 | 1.90 | 5.15 | 1.93 | 6.95 | 2.05 |
| PERKADOX BC-FF | 0.95 | 0.38 | 1.03 | 0.39 | 1.40 | 0.41 |
| TOTAL | 249.70 | 100.00 | 266.18 | 100.00 | 338.35 | 100.00 |
| Hardness (Shore A) | 61 | | 62 | | 59 | |
| Tensile strength | 4.76 | | 4.62 | | 3.65 | |
| at break (MPa) | | | | | | |
| Tensile elongation at | 170 | | 180 | | 170 | |
| break (%) | | | | | | |
| Oil immersion weight | 70 | | 90 | | 80 | |
| increase (125° C./3 days, %) | | | | | | |
| Compression set (125° C./22 hr, %) | 38 | | 37 | | 39 | |
| | Example | | | | | |
| | E11 | | E12 | | E13 | |
| Ingredient | Parts | Wt % | Parts | Wt % | Parts | Wt % |
| FORMOLENE 1102KR | 20.00 | 5.71 | 20.00 | 5.24 | 20.00 | 4.13 |
| SEPTON V9461 | 100.00 | 28.53 | 100.00 | 26.22 | 100.00 | 20.64 |
| SKYPEL G140D | — | — | 30.00 | 11.48 | 50.00 | 13.72 |
| CHEMIGUM P615D | 120.00 | 52.06 | 120.00 | 45.90 | 200.00 | 54.86 |
| PURETOL PSO 380 | 100.00 | 43.38 | 100.00 | 38.25 | 100.00 | 27.43 |
| SILQUEST A-171 | 8.95 | 3.88 | 9.73 | 3.72 | 12.35 | 3.39 |
| PERKADOX BC-FF | 1.57 | 0.68 | 1.70 | 0.65 | 2.20 | 0.60 |
| TOTAL | 230.52 | 100.00 | 261.43 | 100.00 | 364.55 | 100.00 |
| Hardness (Shore A) | 51 | | 55 | | 54 | |
| Tensile strength | 3.72 | | 3.72 | | 2.48 | |
| at break (MPa) | | | | | | |
| Tensile elongation at | 200 | | 160 | | 120 | |
| break (%) | | | | | | |
| Oil immersion weight | 68 | | 62 | | 57 | |
| increase (125° C./3 days, %) | | | | | | |

| | | | |
|---|---|---|---|
| Compression set (125° C./22 hr, %) | 35 | 40 | 50 |

As shown in Table 6, Examples E1, E5, and E8-E10, thermoplastic elastomer articles including para-methylstyrene block copolymer (SEPTON V9461) and rubber (NORDEL IP 4785HM and TSE221) showed a reduced oil immersion weight increase and a reduced compression set as compared to Comparative Example C1, a thermoplastic elastomer of similar hardness including NORDEL IP 4785HM without SEPTON V9461.

As indicated by Comparative Example C1 and Examples E1, E5, and E8-E10, including para-methylstyrene block copolymer and a rubber, results in a thermoplastic elastomer article having improved chemical and heat resistance as compared to a thermoplastic elastomer article that does not include para-methylstyrene block copolymer.

It will be apparent that modifications and variations are possible without departing from the scope of the disclosure defined in the appended claims. More specifically, although some aspects of the present disclosure are identified herein as preferred or particularly advantageous, it is contemplated that the present disclosure is not necessarily limited to these aspects.

What is claimed is:

1. A thermoplastic elastomer article comprising a crosslinked reaction product of:
styrene block copolymer, the styrene block copolymer comprising at least one terminal polymer block A, the at least one terminal polymer block A comprising a vinyl compound having para-alkylstyrene;
rubber, the rubber comprising at least one of ethylene propylene diene rubber, silicone rubber, and nitrile butadiene rubber; and
silane;
wherein the styrene block copolymer and the rubber are silane grafted and silane crosslinked, and
wherein the silane crosslinking is at least one of intramolecular silane crosslinking and intermolecular silane crosslinking.

2. The thermoplastic elastomer article of claim 1, wherein the para-alkylstyrene comprises para-methylstyrene.

3. The thermoplastic elastomer article of claim 1, wherein the crosslinked reaction product comprises a moisture cure reaction product.

4. The thermoplastic elastomer article of claim 1, wherein the at least one terminal polymer block A is silane grafted and silane crosslinked.

5. The thermoplastic elastomer article of claim 1, wherein the thermoplastic elastomer article comprises 2 wt % to 60 wt % of the styrene block copolymer.

6. The thermoplastic elastomer article of claim 1, wherein the thermoplastic elastomer article comprises 1 wt % to 65 wt % of the rubber.

7. The thermoplastic elastomer article of claim 1, wherein the thermoplastic elastomer comprises 5 wt % to 45 wt % of the ethylene propylene diene rubber.

8. The thermoplastic elastomer article of claim 1, wherein the thermoplastic elastomer article comprises 1 wt % to 40 wt % of the silicone rubber.

9. The thermoplastic elastomer article of claim 1, wherein the thermoplastic elastomer article comprises 35 wt % to 65 wt % of the nitrile butadiene rubber.

10. The thermoplastic elastomer article of claim 1, wherein the thermoplastic elastomer article comprises 0.5 wt % to 5 wt % of the silane.

11. The thermoplastic elastomer of claim 1, wherein the silane comprises vinyl trimethoxysilane, vinyl triethoxysilane, or a combination thereof.

12. The thermoplastic elastomer article of claim 1, wherein the silane is included in a solution comprising organic peroxide.

13. The thermoplastic elastomer article of claim 12, wherein the organic peroxide comprises dicumyl peroxide.

14. The thermoplastic elastomer article of claim 1, wherein the thermoplastic elastomer article further comprises at least one of polyolefin and polyolefin elastomer.

15. The thermoplastic elastomer article of claim 14, wherein the thermoplastic elastomer article comprises 1 wt % to 23 wt % of the at least one of the polyolefin and the polyolefin elastomer, or 3 wt % to 20 wt % of the at least one of polyolefin and polyolefin elastomer, or 5 wt % to 17 wt % of the at least one of polyolefin and polyolefin elastomer.

16. The thermoplastic elastomer of claim 14, wherein the polyolefin comprises polypropylene.

17. The thermoplastic elastomer of claim 14, wherein the polyolefin elastomer comprises olefin block copolymer, ethylene alpha-olefin copolymer, or a combination thereof.

18. The thermoplastic elastomer of claim 1, wherein the thermoplastic elastomer article further comprises thermoplastic copolyester.

19. The thermoplastic elastomer article of claim 18, wherein the thermoplastic elastomer article comprises 3 wt % to 20 wt % of the thermoplastic copolyester, or 5 wt % to 17 wt % of the thermoplastic copolyester, or 7 wt % to 15 wt % of the thermoplastic copolyester.

20. The thermoplastic elastomer article of claim 1, wherein the thermoplastic elastomer article further comprises plasticizer.

21. The thermoplastic elastomer article of claim 20, wherein the thermoplastic elastomer article comprises 15 wt % to 65 wt % of the plasticizer, or 17 wt % to 60 wt % of the plasticizer, or 20 wt % to 55 wt % of the plasticizer.

22. The thermoplastic elastomer article of claim 20, wherein the plasticizer comprises mineral oil.

23. A process for making a thermoplastic elastomer article comprising a crosslinked reaction product of styrene block copolymer, rubber, and silane, the styrene block copolymer comprising at least one terminal polymer block A, the at least one terminal polymer block A comprising a vinyl compound having para-alkylstyrene, the rubber comprising at least one of ethylene propylene diene rubber, silicone rubber, and nitrile butadiene rubber, the process comprising the steps of:
blending the styrene block copolymer and the rubber;
grafting the blend with silane such that the styrene block copolymer and the rubber are silane grafted;
shaping the silane-grafted blend; and
curing the shaped, silane-grafted blend such that the styrene block copolymer and the rubber are silane crosslinked.

24. The process of claim 23, wherein the silane is included in a solution comprising organic peroxide.

25. The process of claim 23, wherein the process further includes adding a moisture cure catalyst, the moisture cure catalyst comprising organotin, carboxylic acids, metal complex compounds, aluminum triacetyl acetonate, nickel tetraacetyl acetonate, chromium hexaacetyl acetonate, titanium tetraacetyl acetonate, and metal alkoxides.
